(19) United States
(12) Patent Application Publication
(10) Pub. No.: US 2010/0273051 A1
(43) Pub. Date: Oct. 28, 2010

(54) COMPOSITE ELECTRODE AND METHOD FOR MANUFACTURING THE SAME

(75) Inventors: Hee-Sung CHOI, Suwon-si (KR); Young-Kwan Lee, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/608,357

(22) Filed: Oct. 29, 2009

(30) Foreign Application Priority Data
Apr. 24, 2009 (KR) 10-2009-0036143

(51) Int. Cl. H01M 4/48; H01M 4/60; H01M 4/50; H01M 4/52; H01M 4/58; B05D 5/12; C25D 7/00; H01M 4/04; H01G 9/058

(52) U.S. Cl. 429/213; 429/218.1; 429/231.5; 429/224; 429/223; 429/231.8; 427/77; 205/50; 205/57; 427/78; 361/502; 977/742

(57) ABSTRACT

A composite electrode and a method for manufacturing the same are disclosed. By using a composite electrode that includes a porous support made of ceramic or metal and a conductive polymer or a metal oxide formed on a surface of the porous support, a capacitor or secondary cell that provides increased charge/discharge capacity and increased energy/output density, as well as high-temperature stability and high reliability, can be manufactured.

### CROSS-REFERENCE TO RELATED APPLICATIONS

This application claims the benefit of Korean Patent Application No. 10-2009-0036143, filed with the Korean Intellectual Property Office on Apr. 24, 2009, the disclosure of which is incorporated herein by reference in its entirety.

### BACKGROUND

1. Technical Field

The present invention relates to a composite electrode and to a method for manufacturing the composite electrode.

2. Description of the Related Art

In general, a high-performance portable power supply is a core component of a device that is used in various types of mobile communication devices, electronic devices, electric vehicles, etc. The next-generation energy storage systems currently being developed commonly use electrochemical principles. Examples of such energy storage systems include the lithium-based secondary cell and the electrochemical capacitor.

The electrochemical capacitor is an energy storage apparatus that stores and supplies electrical energy, using the capacitor behavior caused by electrochemical reactions between an electrode and an electrolyte. The electrochemical capacitor has a higher energy density and a higher output density compared to the existing electrolyte capacitor and to the secondary cell and thus has recently garnered much attention as a state-of-the-art energy storage power source capable of quickly storing or supplying a large amount of energy. Due to its ability of supplying a large amount of electric current in a short period of time, it is expected that the electrochemical capacitor will be utilized in a variety of applications, for example, a back-up power source for electronic apparatus, a pulse power source for mobile communication devices, and a high-output power source for hybrid electric vehicles.

The electrochemical capacitor can be divided into the electrical double layer capacitor (EDLC), which utilizes the principle of the electrical double layer forming between an electrode and an electrolyte, and the supercapacitor, which provides an ultra-high capacity about 10 times larger than that of the EDLC type, using the pseudocapacitance generated by Faraday reactions that accompany the movement of electrical charges between the electrode and the electrolyte, such as during adsorption reactions, where ions within the electrolyte are adsorbed onto the surface of the electrode, and during oxidation/reduction reactions at the electrode.

Metal oxides or conductive polymers are commonly used as the material for the electrode of a supercapacitor. Among such materials, oxides of transition metals are currently receiving the most attention, especially ruthenium oxide. However, when using an aqueous electrolyte, the operation voltage of the aqueous electrolyte is limited to 1 V, resulting in a limited energy density.

As such, recent research efforts have focused on developing vanadium oxide, manganese oxide, nickel oxide, cobalt oxide, etc., which can be used as electrode material in an organic electrolyte at an operation voltage of 2.3 V. These materials, however, do not as yet exhibit electrochemical properties comparable to those of ruthenium oxide.

Also, in an effort to improve the electrochemical properties in current metal oxide electrodes, there is a worldwide trend of research aimed at forming a composite electrode by combining metal oxide materials, which provide high specific capacitance, with carbon-based materials, which provide high electric conductivity.

A current method of manufacturing a composite electrode of a carbon-based material and a metal oxide is the pasting method. This method may include forming a paste, by mixing in the carbon-based material during the synthesis of the metal oxide, and adding a conductive material and a binder to the carbon/metal oxide combination, or by mixing in the conductive material and binder, together with the carbon material, to the already-synthesized metal oxide, and then coating the paste onto a current collector.

However, manufacturing a carbon/metal oxide composite electrode by the pasting method may require a complicated process, including multiple time-consuming operations. Also, while the use of the conductive material and the binder is indispensible, they do not participate in the actual electrochemical reactions that provide the specific capacitance of the electrode.

### SUMMARY

An aspect of the invention was developed as a result of researching an electrode support that has a large specific surface area and does not use carbon materials.

Thus, an aspect of the invention provides a composite electrode that has a large specific surface area and high-temperature stability.

One aspect of the invention provides a composite electrode that includes a porous support made of ceramic or metal and a conductive polymer or a metal oxide formed on a surface of the porous support.

Another aspect of the invention provides a composite electrode that includes a porous support made of ceramic or metal, one or more carbon nanotubes formed perpendicularly on a surface of the porous support, and a conductive polymer or a metal oxide formed on a surface of the porous support, on which the carbon nanotubes are formed.

Yet another aspect of the invention provides a composite electrode that includes a porous support made of ceramic or metal and plated with a highly conductive metal component, one or more carbon nanotubes formed perpendicularly on a surface of the plated porous support, and a conductive polymer or a metal oxide formed on a surface of the porous support, on which the carbon nanotubes are formed.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of a composite electrode according to an embodiment of the invention.

FIG. 2 is a cross-sectional view of a composite electrode according to another embodiment of the invention.

FIG. 3 is a cross-sectional view of a composite electrode according to yet another embodiment of the invention.

FIG. 4 is an SEM image of a ceramic support manufactured from short fibers that can be used in an embodiment of the invention.

FIG. 5 is an SEM image of a ceramic support manufactured from long fibers that can be used in an embodiment of the invention.

FIG. 6 is an SEM image of a ceramic support manufactured as a foam structure that can be used in an embodiment of the invention.

FIG. 7 is a schematic diagram of a capacitor according to an embodiment of the invention.

FIG. 8 is a porous ceramic support made from short fibers that can be used in an embodiment of the invention.

FIG. 9 is an SEM image of a ceramic filter coated with polypyrrole according to an embodiment of the invention.

FIG. 10 shows the image of FIG. 9 with a lower level of magnification.

FIG. 11 shows the ceramic fibers of FIG. 9 with a higher level of magnification.

FIG. 12 represents experimental data for an embodiment of the invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While indicators such as (a), (b), etc., may be used to describe various elements, such elements must not be limited to the above indicators. The above indicators are used only to distinguish one element from another.

The terms used in the present specification are merely used to describe particular embodiments, and are not intended to limit the present invention. An expression used in the singular encompasses the expression of the plural, unless it has a clearly different meaning in the context. In the present specification, it is to be understood that terms such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

The composite electrode and method for manufacturing the composite electrode according to certain embodiments of the invention will be described below in more detail with reference to the accompanying drawings. Those elements that are the same or are in correspondence are rendered the same reference numeral regardless of the figure number, and redundant descriptions are omitted.

FIG. 1 illustrates conductive polymers 101 formed on the surface of a ceramic or metal porous support 102 according to an embodiment of the invention.

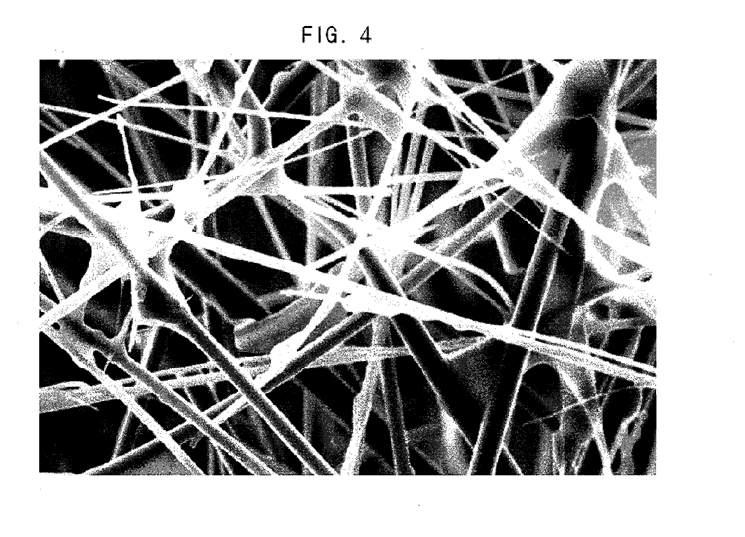

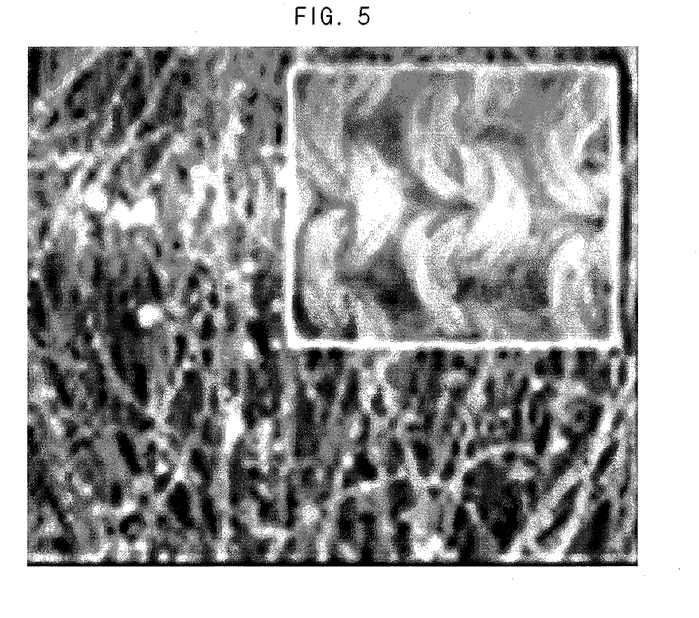

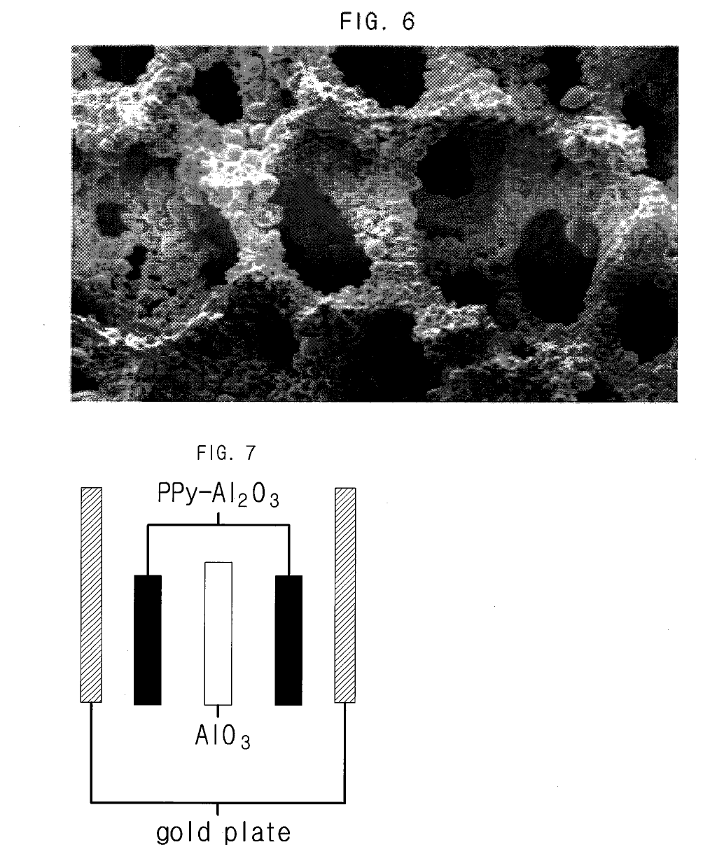

A ceramic porous support applicable to an embodiment of the invention is not limited to a particular type, as long as it provides a surface area suitable for use as an electrode. The ceramic porous support can be, for example, ceramic paper using short fibers, ceramic paper using long fibers, ceramic paper using ceramic fine particles, or a ceramic composition having a foam structure, etc. Specific examples are shown in the drawings, where FIG. 4 illustrates a ceramic paper manufactured from short fibers, FIG. 5 illustrates a ceramic paper manufactured from long fibers, and FIG. 6 illustrates a ceramic composition manufactured as a foam structure.

Using a ceramic porous support can provide high-temperature stability and reliability, so that the electrode using a ceramic porous support, unlike existing electrodes, may be applied to fields where high-temperature curing is required.

A metal porous support can be manufactured using commonly known techniques for manufacturing porous thin films. The metal porous support can be made from such elements as Li, Al, Sn, Bi, Si, Sb, Ni, Cu, Ti, V, Cr, Mn, Fe, Co, Zn, Mo, W, Ag, Au, Pt, Ir, and Ru, or from an alloy or an oxide of these elements.

While the ceramic support may be advantageous in terms of specific surface area and high-temperature stability, it may be needed to form a conductive layer on a surface of the ceramic support, if the ceramic support is to be used on an electrode.

An embodiment of the invention can include forming a conductive polymer or a metal oxide on a surface of the porous support, to utilize the porous support as an electrode.

Examples of conductive polymers include polyacetylene, polyaniline, polypyrrole, polythiophene, and polyethylenedioxythiophene, while examples of metal oxides include vanadium salt, manganese salt, nickel salt, cobalt salt, iridium salt, and ruthenium salt.

Forming the conductive polymer on a surface of the porous support may utilize a method of immersing the support in a solution of monomers of the conductive polymer. After the immersion in the monomer solution, the conductive polymer can be polymerized through known polymerizing processes.

For example, an electrochemical oxidative polymerization can be used. The electrochemical oxidative polymerization of the monomers can be performed at a temperature between −78° C. and the boiling point of the solvent being used. In certain examples, the electrochemical polymerization may be performed at −78 to 250° C., and in certain cases, at −20 to 60° C.

The reaction time may vary between 1 minute and 24 hours, depending on the monomer and electrolyte being used, as well as the selected temperature and the current density.

In cases where the monomers are in a liquid state, electropolymerization can be performed, under electropolymerization conditions in the presence or absence of an inactive solvent. Electropolymerization for solid monomers can be performed under electropolymerization conditions in the presence of an inactive solvent. In certain cases, it can be advantageous to use a solvent mixture and (or) add a solubilizing agent (detergent) to the solvent.

The porous support according to an aspect of the invention may form a 3-dimensional structure, and may be very stable chemically, so that an electrochemical method can be used to form a metal oxide layer on the support surface. Conventional methods of forming a metal oxide layer on a thin film, such as sputtering and spin coating methods, are typically performed at high temperatures and high pressures. While these methods can be used to form an even layer of metal oxide over a flat board, they cannot be used to form an even metal oxide layer over the surface of a complicated shape, such as that of the 3-dimensional porous structure. By employing an electrochemical method, which is performed at normal temperature and normal pressure, the metal oxide layer can be formed on the complex shape of the 3-dimensional porous structure.

As an embodiment of the invention forms a 3-dimensional porous structure, this method becomes a feasible option.

To form the metal oxide layer, first, a metal oxide electrodeposition liquid may be manufactured. The metal oxide electrodeposition liquid may be manufactured by dissolving a metal salt, a specific example of which may include a transition metal salt, such as vanadium salt, manganese salt, nickel salt, cobalt salt, iridium salt, ruthenium salt, etc., in deionized water, and afterwards adding a small amount of an acid or a base solution, a specific example of which may include NaOH or H₂SO₄, etc., adjusting the solution to a pH between 1 and 10. Here, a temperature adjustment apparatus can be used to adjust the temperature of the metal oxide electrodeposition liquid to a value between 10 and 90° C., since a temperature below 10° C. can make it difficult to electrochemically produce metal oxides, while a temperature above 90° C. can cause the electrodeposition liquid to evaporate.

The metal oxide layer formed from the above metal oxide can maintain a thickness range of 1 to 200 nm, since a thickness below 1 nm can cause the manufactured composite electrode having a 3-dimensional porous structure to exhibit an insufficient level of electrochemical properties, a specific example of which may include insufficient discharge current per unit area, whereas a thickness above 200 nm can make it difficult to maintain a porous structure, as the metal oxide layer may fill in the pores of the 3-dimensional porous structure.

Next, the 3-dimensional ceramic porous support may be immersed in the metal oxide electrodeposition liquid manufactured above.

Next, a metal oxide layer may be formed on the support by an electrochemical method to manufacture the composite electrode.

The electrochemical method can include, for example, the constant current method, the constant potential method, the cyclic current method, etc., each of which can involve adjusting parameters so that the thickness of the metal oxide is freely adjusted within the range described above.

In certain specific examples, the constant current method can be performed using a current within a range of 0.01 to 100 mA/cm² with the current supplied for a period of 1 to 500 minutes, the constant potential method can be performed using a potential within a range of 0.1 to 1.5 V with the potential supplied for 1 to 500 minutes, and the cyclic current method can be performed using a potential sweep rate within a range of 1 to 1000 mV/s with 1 to 500 rounds of potential sweeping.

As the electrochemical method is typically performed at normal temperature and normal pressure, it is possible to maintain more temperate conditions compared to the high-temperature, high-pressure conditions typically required in forming a metal oxide layer.

Next, a thermal treatment may be applied to the composite electrode manufactured above at a temperature of 50 to 400° C. for about 1 to 48 hours, to activate the electrode and thus enhance the electrochemical properties of the composite electrode. If the thermal treatment is applied at a temperature below 50° C., the activating effect on the electrode can be deficient, whereas if the thermal treatment is applied at a temperature above 400° C., the chemical stability can be lowered.

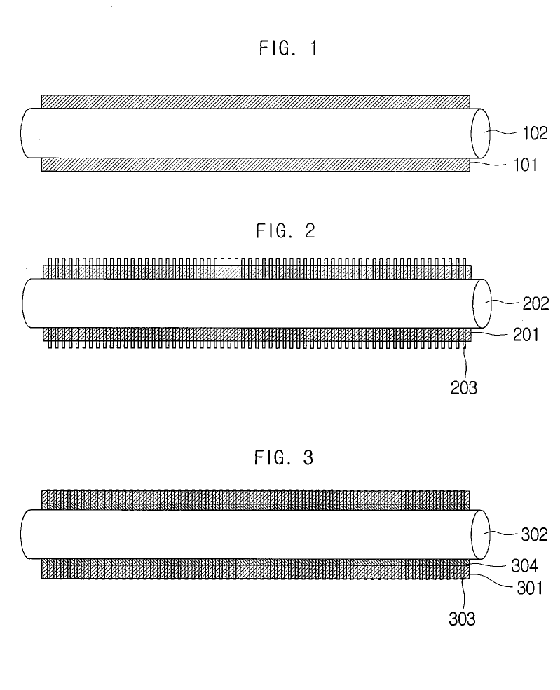

Another embodiment of the invention provides a composite electrode that includes a porous support 202, a conductive polymer 201, and carbon nanotubes 203, as illustrated in FIG. 2.

Compared to the embodiment described above and illustrated in FIG. 1, this embodiment further includes carbon nanotubes 203, which may serve to increase the specific surface area of the electrode. To efficiently increase the surface area and improve the performance of the electrode, the carbon nanotubes may advantageously be formed perpendicularly to the porous support.

A method of forming the carbon nanotubes may include a chemical vapor deposition (CVD) method, which includes forming a growth catalyst, such as Ni, Co, Fe, etc., on the surface of the porous support, and applying a reactive gas, such as a hydrocarbon compound (for example, C₂H₂, C₂H₄, CH₄, C₂H₆), etc. Of course, the invention is not thus limited, and any of various other methods can be used that enables the forming of carbon nanotubes perpendicularly on the support.

The porous support 202, on which the carbon nanotubes 203 are formed perpendicularly, can further include a conductive polymer 201 or a metal oxide on the surface, as in the embodiment described above with reference to FIG. 1.

The conductive polymer 201, metal oxide, and porous support 202 can be substantially the same as those described above.

Yet another embodiment of the invention provides a composite electrode that includes a porous support 302, a conductive polymer 301, carbon nanotubes 303, and a plating layer 304, as illustrated in FIG. 3.

The difference from the previously described embodiment of the invention is that the porous support 302 is plated with a metal component that is high in conductivity.

One reason for plating the porous support 302 with metal is to further improve its conductivity. Any method of plating the porous support having a 3-dimensional structure can be employed in an embodiment of the invention.

The carbon nanotubes 303, conductive polymer 301, and porous support 302 can be substantially the same as those described above.

### Example 1

A composite electrode was manufactured using a ceramic filter, composed mainly of Al₂O₃ fibers, as the support. A product from the Kaowool Paper 1260 line, from the Morgan Crucible Company, was used for the ceramic paper.

The dried ceramic filter was immersed in pyrrole monomers, and then placed in an aqueous iron oxide solution to perform chemical polymerization. The polypyrrole-ceramic filter electrode thus obtained was cleansed using water and ethanol, and subsequently dried.

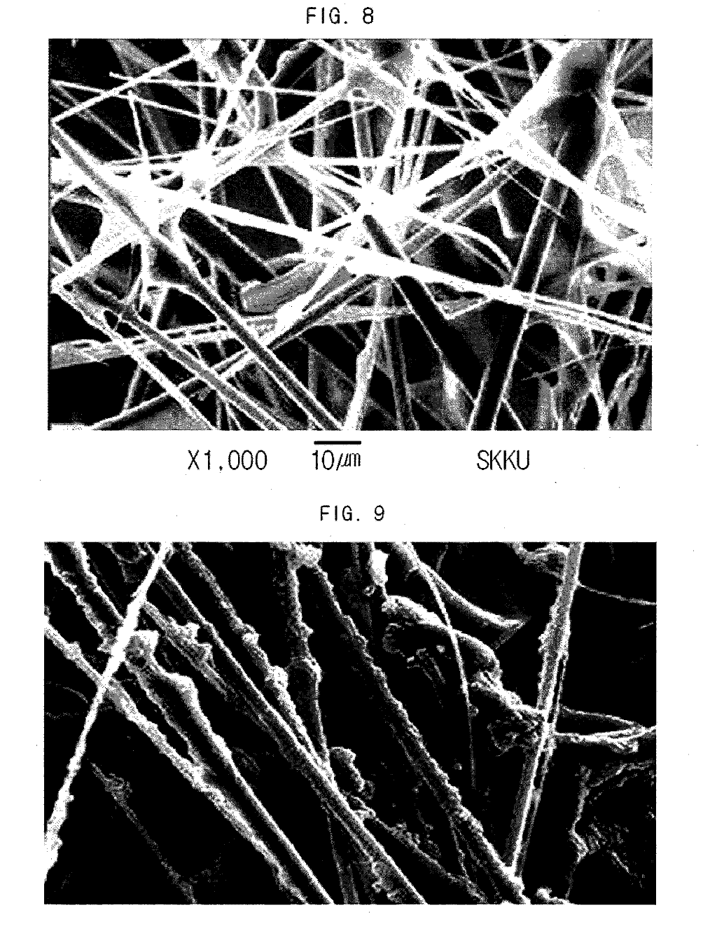

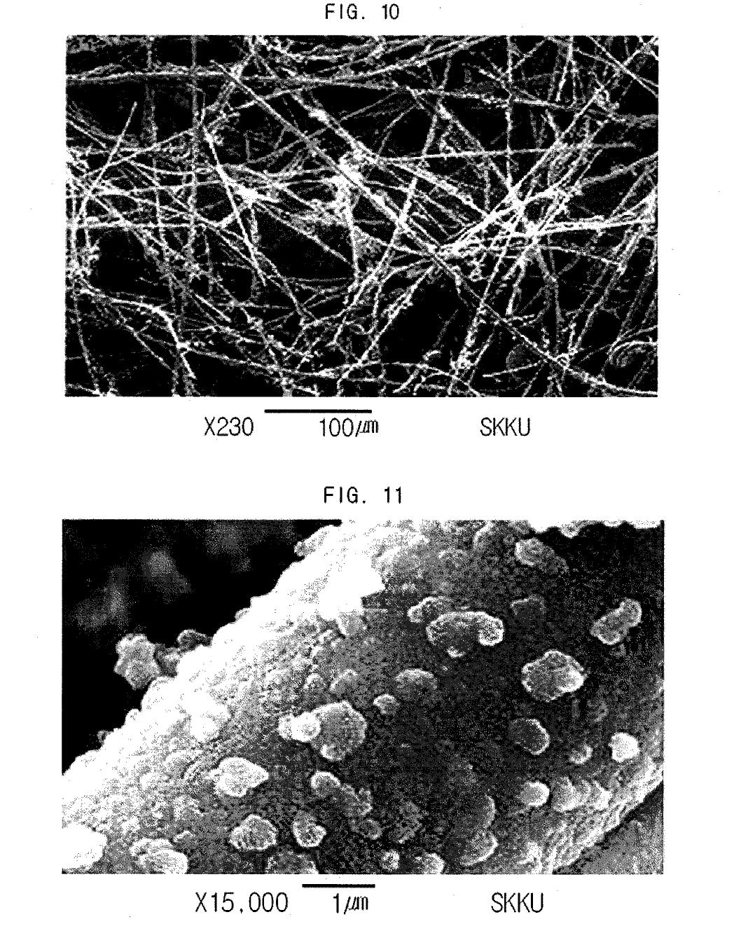

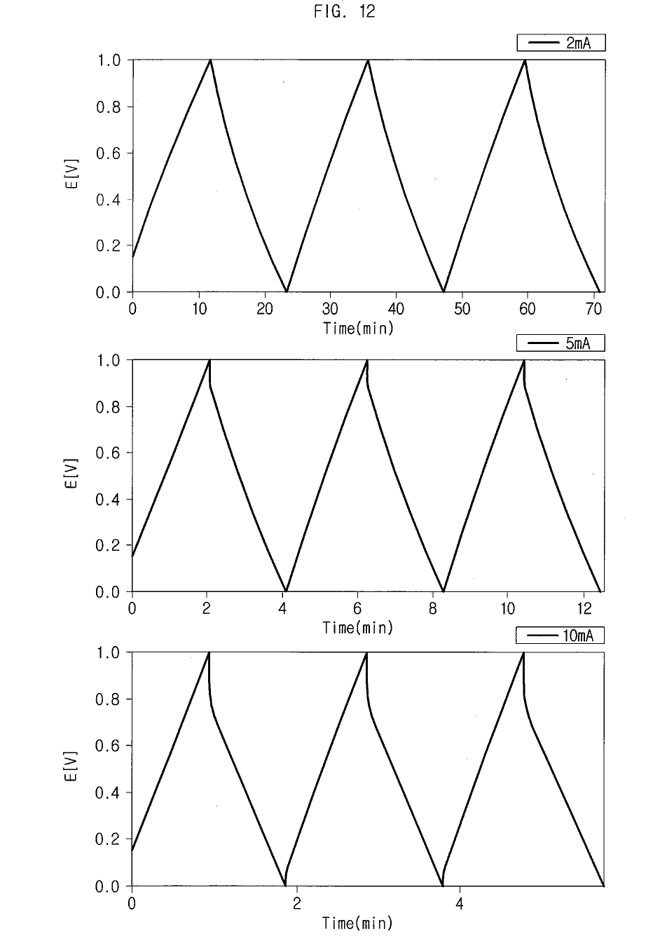

FIG. 8 shows a pure ceramic filter before polymerization. FIG. 9 is an SEM image of the ceramic filter coated with polypyrrole after polymerization, while FIG. 10 shows the image with a lower level of magnification, and FIG. 11 is the image magnified to show a single ceramic fiber. Through the drawings, it can be observed that the polypyrrole has been coated well over the ceramic fibers.

### Example 2

A composite electrode was manufactured using the ceramic filter used in Example 1 as the support. On the surface of the support, carbon nanotubes were grown perpendicularly to the surface of the support, using Ni as the growth catalyst and methane gas as the reactive gas. The Ni growth catalyst layer was produced to a thickness of 20 to 30 nm using sputtering. Afterwards, the carbon nanotubes were grown using a plasma-enhanced chemical vapor deposition (PECVD) method. Here, ammonia gas was used to create a reducing atmosphere, with a flow rate of 100 to 130 sccm and a vacuum degree of 1.2 to 1.3 ton. With the temperature of the substrate at 700° C., acetylene gas was supplied for 20 minutes at 30 sccm, to grow carbon nanotubes. Afterwards, polypyrrole was formed on the surface of the ceramic support having carbon nanotubes, using substantially the same method as that of Example 1.

### Example 3

Using the ceramic filter used in Example 1 as the support, the surface of the support was plated with silver particles. The plating was performed using a method of sequentially applying electroless copper plating and electroplating.

After the plating, carbon nanotubes were formed, and polypyrrole was formed, using substantially the same method as that of Example 2.

### Test Example

Using the ceramic filter coated with polypyrrole prepared in Example 1 as the material for activating the electrode, the same ceramic filter used for polymerization as a separation membrane, and gold as a current collector, the resulting electrochemical properties were measured, and the capacitance was calculated. FIG. 7 is a representation of the capacitor.

FIG. 12 is a graph of the results obtained when charging the manufactured electrode at normal temperature to 1 V with current densities of 2 mA·cm⁻², 5 mA·cm⁻², and 10 mA·cm⁻². The capacitance can be measured using a charge/discharge test method, where the following equation can be applied to a section of the discharge curve that shows a straight line to obtain the capacitance.

C=i·Δt/ΔV [Equation 1]

i represents current, and Δt represents the time it takes for a change in voltage of ΔV to occur. Since the current density applied to each electrode and the final voltage are constant using a charge/discharge test method, the time required for discharging can be used as an indicator of capacitance. The capacitance values calculated by Equation 1 were divided by the weight of the electrode material to yield specific capacitance values. These are listed below in Table 1.

TABLE 1

| Current | 2 mA | 5 mA | 10 mA |
|---|---|---|---|
| Specific capacitance | 176.47 | 78.78 | 72.59 |
| (F/g) | | | |
| Coulombic efficiency | 95.17 | 98.60 | 98.87 |
| (%) | | | |

It can be observed from charge/discharge tests that the prepared electrodes showed charge/discharge efficiency values of over 95% for all of the measured current densities. The charge/discharge efficiency for each current density is shown above in Table 1. All cases showed very high charge/discharge efficiency values of over 95%.

As set forth above, when a composite electrode according to certain embodiments of the invention is used to manufacture a capacitor or a secondary cell, the increase in specific surface area can increase charge/discharge capacity as well as energy/output density, and can also increase stability at high temperatures.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

Many embodiments other than those set forth above can be found in the appended claims.

What is claimed is:

1. A composite electrode comprising:
a porous support made of ceramic or metal; and
a conductive polymer or a metal oxide formed on a surface of the porous support.

2. A composite electrode comprising:
a porous support made of ceramic or metal;
one or more carbon nanotubes formed perpendicularly on a surface of the porous support; and
a conductive polymer or a metal oxide formed on a surface of the porous support having the carbon nanotubes formed thereon.

3. A composite electrode comprising:
a porous support made of ceramic or metal and plated with a highly conductive metal component;
one or more carbon nanotubes formed perpendicularly on a surface of the plated porous support; and
a conductive polymer or a metal oxide formed on a surface of the porous support having the carbon nanotubes formed thereon.

4. The composite electrode according to claim 1, wherein the ceramic porous support is a ceramic composition having a paper-like or foam-like internal structure using short fibers, long fibers, or ceramic fine particles.

5. The composite electrode according to claim 1, wherein the conductive polymer is one or more selected from the group consisting of polyacetylene, polyaniline, polypyrrole, polythiophene, and polyethylenedioxythiophene.

6. The composite electrode according to claim 1, wherein the metal oxide is one or more selected from the group consisting of vanadium salt, manganese salt, nickel salt, cobalt salt, iridium salt, and ruthenium salt.

7. A method for manufacturing a composite electrode, the method comprising:
(a) preparing a porous support made of ceramic or metal; and
(b) treating a surface of the porous support with a conductive polymer or a metal oxide.

8. A method for manufacturing a composite electrode, the method comprising:
(a) preparing a porous support made of ceramic or metal; and
(b) forming one or more carbon nanotubes perpendicularly on a surface of the porous support; and
(c) treating a surface of the porous support having the carbon nanotubes formed thereon with a conductive polymer or a metal oxide.

9. A method for manufacturing a composite electrode, the method comprising:
(a) preparing a porous support made of ceramic or metal; and
(b) plating the porous support with a highly conductive metal component;
(c) forming one or more carbon nanotubes perpendicularly on a surface of the plated porous support; and
(d) treating a surface of the porous support having the carbon nanotubes formed thereon with a conductive polymer or a metal oxide.

10. The method according to claim 7, wherein the treating of the surface of the porous support with a conductive polymer or a metal oxide utilizes:
a method of immersing the porous support in a monomer solution or an electrodeposition liquid; or
an electrochemical method.

11. The method according to claim 8, wherein the forming of the carbon nanotubes utilizes a method of forming a growth catalyst layer on the surface of the porous support, and forming the carbon nanotubes by chemical vapor deposition (CVD) using a hydrocarbon-based reactive gas.

12. The method according to claim 7, wherein the ceramic porous support has a paper-like or foam-like structure using short fibers, long fibers, or ceramic fine particles.

13. The method according to claim 7, wherein the conductive polymer is one or more selected from the group consisting of polyacetylene, polyaniline, polypyrrole, polythiophene, and polyethylenedioxythiophene.

14. The method according to claim 7, wherein the metal oxide is one or more selected from the group consisting of vanadium salt, manganese salt, nickel salt, cobalt salt, iridium salt, and ruthenium salt.
